(19) United States
(12) Patent Application Publication
(10) Pub. No.: US 2026/0163917 A1
(43) Pub. Date: Jun. 11, 2026

(54) CYBERSECURITY SYSTEM AND METHOD

(71) Applicant: Jeremy R. Deutsch, New York, NY (US)

(72) Inventor: Jeremy R. Deutsch, New York, NY (US)

(21) Appl. No.: 19/183,450

(22) Filed: Apr. 18, 2025

Related U.S. Application Data
(60) Provisional application No. 63/636,368, filed on Apr. 19, 2024.

(51) Int. Cl. H04L 9/40

(52) U.S. Cl. CPC H04L 63/1491; H04L 63/08

(57) ABSTRACT

A cybersecurity system includes a monitoring component configured to observe authentication requests from one or more endpoints directed to one or more authentication systems, an analysis component configured to identify authentication requests from endpoints not requiring decryption that exceed a predefined threshold, wherein the threshold includes a number of authentication requests within a period of time, and a mitigation component configured to initiate an automated response to authentication requests from endpoints not requiring decryption that exceed the predefined threshold, wherein the response includes at least one of limiting authentication requests, delaying authentication requests, and blocking authentication requests. A cybersecurity method is also disclosed.

### CROSS-REFERENCE TO RELATED APPLICATIONS

This application claims priority to U.S. Provisional Application No. 63/636,368 filed on Apr. 19, 2024, incorporated herein by reference in its entirety.

### BACKGROUND OF THE INVENTION

The known defenses against cyberattacks (e.g., bot attack, distributed denial-of-service (DDoS) attack) are insufficient in addressing the attacks and do not provide adequate cyber security. Current considerations may include disabling local authentication as a potential solution to mitigate performance issues by reducing CPU load, though this still allows an attack to persist. Another typical strategy is to disable logins and minimize system calls to Lightweight Directory Access Protocol (LDAP) or Remote Authentication Dial-In User Service (RADIUS) servers which may alleviate CPU stress. However, threats can be more extensive involving log flooding and email system inundations, creating optimal conditions for buffer overflows or system failures.

The repeated failure of login attempts can cause minor memory leaks. When such failures occur millions of times within an hour, they can accumulate, potentially leading to system crashes or unauthorized access. The support systems for LDAP or RADIUS, which respond to the virtual private network (VPN) requests prior to the enforcement of local authentication only, are also critically stressed under these conditions. Allowing 10,000 logins from a single endpoint within five minutes is unprecedented and should not be feasible, as it could overwhelm downstream login systems and confuse administrators. Processing such a volume of transactions could likely precipitate new exploits.

Thus, there is a need in the art for cybersecurity systems and methods for preventing cyberattacks such as bot attacks or DDoS attacks. The present invention satisfies that need.

### SUMMARY OF THE INVENTION

In some aspects, a cybersecurity system includes a monitoring component configured to observe authentication requests from one or more endpoints directed to one or more authentication systems, an analysis component configured to identify authentication requests from endpoints not requiring decryption that exceed a predefined threshold, wherein the threshold includes a number of authentication requests within a period of time, and a mitigation component configured to initiate an automated response to authentication requests from endpoints not requiring decryption that exceed the predefined threshold, wherein the response includes at least one of limiting authentication requests, delaying authentication requests, and blocking authentication requests.

In some embodiments, the response includes applying a progressive cooldown algorithm that increases a delay for authentication requests from the one or more endpoints after each consecutive authentication request. In some embodiments, the response includes blacklisting the one or more endpoints that exceed the predefined threshold.

In some embodiments, the mitigation component includes an endpoint whitelisting mechanism that excludes one or more endpoints from the automated response. In some embodiments, the number of authentication requests range between 5 and 50,000 requests, and the period of time ranges between 1 second and 20 minutes. In some embodiments, the mitigation component is further configured to dynamically adjust the predefined threshold based on time of day, historical usage patterns, or authentication system load.

In some embodiments, the analysis component is configured to evaluate patterns of authentication requests using a real-time sliding window for comparison against historical authentication requests. In some embodiments, the analysis component is configured to evaluate patterns of authentication requests that result in memory exhaustion or memory leak, and initiate the automated response based on the patterns of authentication requests.

In some embodiments, the system further includes a logging component that aggregates failed authentication requests and transmits a report of the failed authentication requests to upstream systems. In some embodiments, the report includes contextual threat diagnostics comprising at least one of endpoint origin, number of authentication attempts, authentication attempt frequency, and impacted services. In some embodiments, the system further includes a firmware component operating on a network device that applies the automated response of the mitigation component without requiring modification of the devices authentication services.

In some embodiments, the mitigation component is further configured to redirect authentication requests from endpoints exceeding the predefined threshold to one or more honeypot systems that simulate the one or more authentication systems. In some embodiments, the one or more honeypot systems comprise at least one of: an internal virtualized honeypot, a downstream honeypot network, and an upstream honeypot network coordinated through communication with internet service providers.

In some embodiments, the mitigation component is further configured to manipulate network traffic characteristics for authentication requests from endpoints exceeding the predefined threshold to create a perception of a larger or geographically distributed network topology. In some embodiments, the traffic manipulation comprises at least one of: injecting artificial latency, modifying packet time-to-live values, and simulating distributed server response patterns.

In some embodiments, the system further includes an intelligence gathering component that analyzes attack patterns captured in honeypot systems and feeds behavioral signatures back to the analysis component to improve detection capabilities.

In some embodiments, the analysis component includes a game theory engine configured to model attacker incentives and determine optimal defensive responses to disincentivize continued attack behavior.

In some embodiments, the mitigation component is further configured to employ artificial intelligence to develop and deploy attack-specific countermeasures based on analysis of attack patterns observed in honeypot environments.

In some embodiments, the monitoring component is further configured to detect distributed authentication signals across multiple network endpoints, wherein legitimate authentication requires specific interaction patterns with seemingly unrelated services. In some embodiments, the authentication signals comprise a predetermined sequence of connections to sensor endpoints that must occur before authentication attempts will be processed.

In some embodiments, the mitigation component includes an automated system for communicating with one or more internet service providers about attack sources, wherein the communication includes automatically researched provider-specific contact information and appropriately formatted abuse notifications.

In some aspects, a cybersecurity method includes monitoring authentication requests from one or more endpoints directed to one or more authentication systems, identifying authentication requests from endpoints not requiring decryption that exceed a predefined threshold, wherein the threshold includes a number of authentication requests within a period of time, and initiating an automated response to authentication requests from endpoints not requiring decryption that exceed the predefined threshold, wherein the response includes at least one of limiting authentication requests, delaying authentication requests, and blocking authentication requests.

In some embodiments, the response includes applying a progressive cooldown algorithm that increases a delay for authentication requests from the one or more endpoints after each consecutive authentication request. In some embodiments, the response includes blacklisting the one or more endpoints that exceed the predefined threshold. In some embodiments, the method further includes whitelisting one or more endpoints to exclude the endpoints from the automated response. In some embodiments, the number of requests range between 100 and 50,000 requests, and the period of time ranges between 1 second and 20 minutes.

In some embodiments, the method further includes evaluating patterns of authentication requests using a real-time sliding window for comparison against historical authentication requests. In some embodiments, the method further includes evaluating patterns of authentication requests that result in memory exhaustion or memory leak, and initiating the automated response based the patterns of authentication requests.

In some embodiments, the method further includes aggregating failed authentication requests, and transmitting a report of the failed authentication requests to upstream systems. In some embodiments, the report includes contextual threat diagnostics comprising at least one of endpoint origin, number of authentication attempts, authentication attempt frequency, and impacted services.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a diagram of an exemplary cybersecurity system according to aspects of the present invention;

FIG. 1B is a diagram of an exemplary cybersecurity system according to aspects of the present invention;

FIG. 2A is a diagram of an exemplary cybersecurity system according to aspects of the present invention;

FIG. 2B is a diagram of an exemplary cybersecurity system according to aspects of the present invention;

FIG. 3 is a diagram of a current system allowing a cyberattack;

FIG. 4 is a diagram of a current system allowing a cyberattack;

FIG. 5 is a diagram of an exemplary cybersecurity system preventing a cyberattack according to aspects of the present invention;

FIG. 6 is a diagram of an exemplary cybersecurity system preventing a cyberattack and reporting blocked attacker identifiers (e.g., IP address) to one or more upstream systems;

FIG. 7 is a diagram of an exemplary cybersecurity system preventing any traffic of a cyberattack at any physical and/or virtual interfaces;

FIG. 8 is a flowchart of an exemplary cybersecurity method according to aspects of the present invention; and

FIG. 9 is a diagram of a computing environment.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

A cyberattack is defined as a malicious, intentional attempt by an individual or group to gain unauthorized access to a computer system or network, with the goal of stealing, damaging, or disrupting data, applications, or other assets.

A distributed denial-of-service (DDoS) attack is defined as a type of cyberattack where an attacker overwhelms a website, server, or network resource with malicious traffic. As a result, the target crashes or is unable to operate, denying service to legitimate users and preventing legitimate traffic from arriving at its destination.

A host operating system (OS) is defined as a primary operating system installed on a computer's hardware, managing its resources and providing services for software applications, and is the foundation for running virtual machines (VMs) or containers.

A guest operating system (guest OS) is defined as an operating system that runs within a VM, created and managed by a host OS. It operates in an isolated environment, allowing multiple operating systems to run on a single physical machine.

A hypervisor, also known as a virtual machine monitor (VMM), is defined as a software that allows multiple VMs to run on a single physical computer, sharing resources like CPU, memory, and storage.

An intrusion prevention system (IPS), also known as an intrusion detection and prevention system (IDPS), is a defined as a network security technology or system that monitors network traffic and takes automated actions to prevent potential threats and unauthorized access.

A firewall is defined as a network security system that monitors and controls incoming and outgoing network traffic based on pre-defined security rules, acting as a barrier between a trusted internal network and untrusted external networks like the internet.

A virtual private network (VPN) is defined as an arrangement whereby a secure, apparently private network is achieved using encryption over a public network, typically the internet.

External client computing is defined as a client-server model where a client (a computer or software application) accesses resources or services from a server that is located outside the client's immediate network or environment.

An external client is defined as a client that is not part of the internal network or organization, but accesses resources or services from a remote server over a network, like the internet.

An endpoint is defined as any physical or virtual device that connects to a network, acting as a point of entry or exit for data, and includes devices like desktops, laptops, mobile phones, servers, and IoT devices.

An authentication endpoint is defined as a specific URL, device (e.g., firewall), or a point of contact, that an application or client uses to interact with a system or service to verify their identity and gain access to protected resources.

Secure Sockets Layer (SSL) is defined as a standard security technology for establishing an encrypted link between an authentication endpoint (e.g., a server) and a client.

Untimely access is defined as situations where a user needs to access a network or resources that are restricted or unavailable at certain times, or when a VPN connection is unexpectedly terminated or delayed. This can be due to various reasons, including network issues, VPN server problems, or security protocols.

A Lightweight Directory Access Protocol (LDAP) server is defined as a directory service that stores and manages user accounts, groups, and other directory data, allowing applications to access and authenticate users across a network.

A Remote Authentication Dial-In User Service (RADIUS) server is defined as a network server that authenticates, authorizes, and accounts for users trying to access networks and VPNs, often referred to as an Authentication, Authorization, and Accounting (AAA) server.

A demilitarized zone (DMZ) network is defined as a security-focused subnetwork that sits between an organization's internal network and the external, untrusted network (like the internet), acting as a buffer to protect sensitive internal data while allowing access to public-facing services.

Upstream system are defined as one or more systems that sends data to another system, acting as a source of information.

Downstream systems are defined as one or more systems that receive data or instructions from other systems (upstream systems), processing or using that data for their own purposes.

Security Information and Event Management (SIEM) platforms are defined as centralized solutions that collect, analyze, and correlate security logs and events from various sources to detect and respond to threats in real-time.

A honeypot in cybersecurity is defined as a decoy system designed to detect, attract, deflect and study cyber attackers. It's a fake target that looks like a legitimate system, such as a server or network, with intentionally built vulnerabilities to entice attackers. By luring attackers into the honeypot, security professionals can observe their tactics, techniques, and procedures (TTPs), and gather valuable intelligence about their methods and intentions. This information can be used to improve security measures and respond to real-world threats.

Disclosed herein is a cybersecurity system and method that provides network layer protection that detects excessive authentication attempts—for example thousands in scenarios typically expecting around 100 logins per minute—and subsequently blocks the IPs responsible for this abnormal activity. In some embodiments, the disclosed cybersecurity system and method addresses cyberattacks that may involve log flooding and email system inundations, and prevents buffer overflows or system failures. For example, the disclosed system and method prevents excessive logging from failed login attempts, which are particularly problematic when managing 10,000 login attempts in five minutes, such as using SSL and NetExtender, a SonicWALL® VPN tool. Further, the disclosed cybersecurity system and method can prevent repeated failure of login attempts which can cause memory leaks. When such failures occur millions of times within an hour, they can accumulate, potentially leading to system crashes or unauthorized access. The support systems for LDAP or RADIUS, which respond to VPN requests prior to the enforcement of local authentication only, are also critically stressed under these conditions. The disclosed system and method address these issues preventing unnecessary stress on the network and components, as well as preventing system crashes and unauthorized access.

The disclosed cybersecurity system and method provides a fix to a frequent security flaw: a DDoS-style attack not just targeting the VPN appliance but affecting the entire authentication and logging framework. Allowing 10,000 logins from a single endpoint within five minutes can overwhelm downstream login systems and confuse administrators. Processing such a volume of transactions may likely precipitate new exploits. In some embodiments, the disclosed cybersecurity system and method comprises implementing a cooldown period after a set number of failed login attempts or blocking IPs altogether when they exceed a specified failure threshold within a given timeframe. An example implementation is discussed in the example section below, showing that the disclosed cybersecurity system and method provides an expedient, convenient and comprehensive cybersecurity solution.

The disclosed system provides a framework for configuring virtual and/or physical networks for protection against cyberattacks (e.g., Bot attacks, DDoS, etc.). In some embodiments, the disclosed system operates with or resides on a computing device (e.g., a firewall device, a server, computer 500 disclosed herein) and may comprise physical and/or virtual modules, components, assets and/or features as discussed herein. In some embodiments, the system is configured as a virtual system, or as a software that may operate on computers or networking devices. In some embodiments, the disclosed cybersecurity system and method may comprise a firmware that incorporates the disclosed technology into existing devices (e.g., firewalls). It should be appreciated that various generic parts or features of physical and virtual systems may not be shown or described herein as they do not facilitate a better understanding of the disclosed system and method. It should also be appreciated that when describing the systems and methods of the present invention, the components, modules, assets and/or features may take the form of physical appliances or devices, or exist in logical or virtual form (e.g., a physical network interface vs a virtual network interface). Further, the disclosed system may comprise any modules, components, assets and/or features of computers, networking devices (e.g., firewalls, switches, interfaces), software, and the like, as would be known by one of ordinary level of skill in the art.

In some aspects, the present invention relates to a cybersecurity system and method for mitigating high-volume authentication-based attacks that threaten the stability of computing systems, particularly in environments where authentication is managed through centralized services such as VPN appliances, LDAP servers, or RADIUS protocols. This disclosure introduces a dynamic, behavior-based approach to detecting and mitigating excessive login attempts—whether malicious or unintentionally, by observing authentication traffic patterns and initiating responsive protective actions before such traffic results in system overload, memory exhaustion, or service failure.

Unlike traditional rate-limiting mechanisms or strategies that disable local authentication outright, this invention operates at the network and behavioral level. It continuously monitors incoming authentication traffic and uses predefined thresholds or behavioral baselines to identify anomalies. Upon detection of authentication request volumes that exceed expected norms—such as 10,000 requests from a single endpoint in a five-minute window, the system engages mitigation mechanisms including request throttling, cooldown timers, or IP blocking. These mechanisms are intelligently applied to isolate the disruptive source while preserving service continuity for legitimate users.

A key aspect of the invention lies in its holistic treatment of authentication overload not merely as a user-access problem, but as a systemic risk that can propagate across dependent services. For example, failed login floods can generate log files at rates that overwhelm logging systems, trigger false alarms in administrative dashboards, or even cause buffer overflows. Additionally, repeated failed authentications can cause memory leaks in authentication subsystems, eventually leading to service degradation or crash. This invention addresses these risks by integrating log correlation and threat visualization, enabling administrators to see patterns across services and respond appropriately.

The system also offers the flexibility to incorporate whitelisting and exception logic, ensuring trusted IPs or known users are not inadvertently penalized. This adaptability is critical in enterprise environments where remote access services (such as SSL VPN clients) may exhibit high volumes of legitimate login activity. Furthermore, the system is designed to be implemented as firmware within network appliances or as middleware across authentication infrastructure, allowing it to integrate without requiring architectural overhauls. The disclosed cybersecurity system and method provides a layered and intelligent defense against an emerging class of denial-of-service attacks (i.e., bot attacks) targeting authentication systems. By detecting anomalous behavior early, enforcing dynamic mitigation, and correlating signals across network layers and services, this system enables robust operational resilience in mission-critical environments.

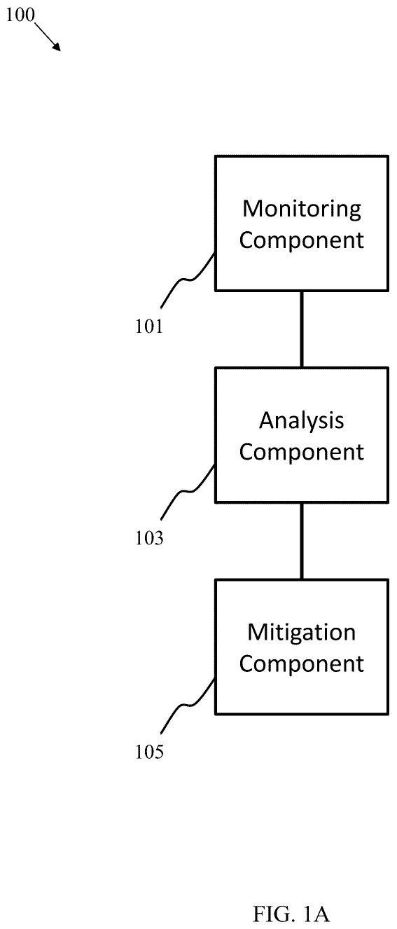

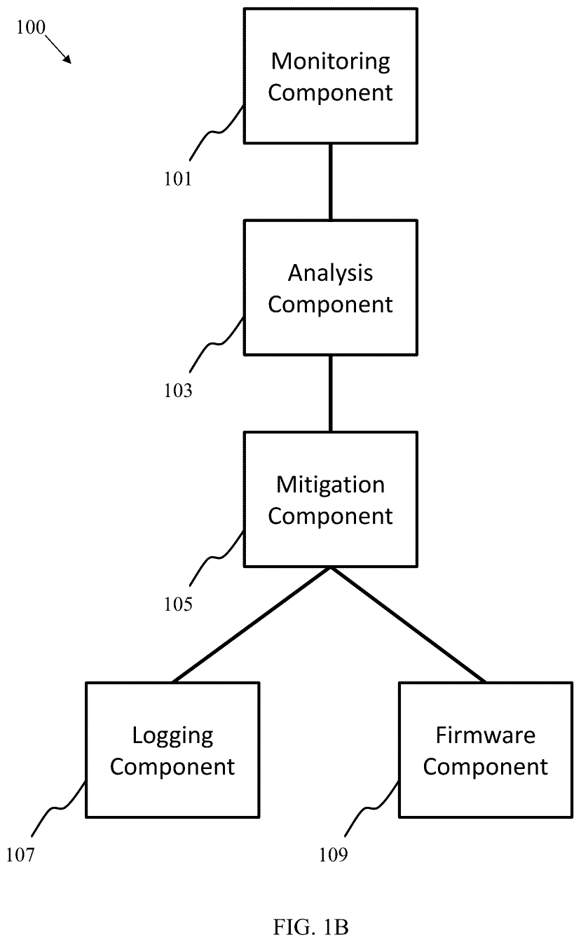

Referring now to FIG. 1, shown is an exemplary cybersecurity system 100 comprising a monitoring component 101, an analysis component 103, and a mitigation component 105, each in communication and operatively connected with the other components. In some embodiments, the monitoring component 101 (e.g., a networking monitoring component or module) is configured to observe and analyze authentication traffic directed to one or more authentication endpoints, including but not limited to virtual networks, VPN appliances, LDAP servers, and RADIUS servers. In some embodiments, the monitoring component 101 utilizes deep packet inspection (DPI) to extract and analyze authentication payloads for protocol-specific anomalies, including excessive SSL handshakes, handshake frequency, and/or malformed VPN request (e.g., NetExtender requests) detection. In some embodiments, the monitoring component 101 is configured to inspect authentication requests at the network protocol level, including inspection of packet headers and metadata without decrypting payload contents. In some embodiments, the monitoring component 101 is further configured to detect distributed authentication signals across multiple network endpoints, wherein legitimate authentication requires specific interaction patterns with seemingly unrelated services. In some embodiments, the authentication signals comprise a predetermined sequence of connections to sensor endpoints that must occur before authentication attempts will be processed.

In some embodiments, the analysis component 103 (e.g., behavioral analysis component, engine, or module) is configured to identify authentication traffic exceeding a predefined threshold of login attempts per unit of time from one or more network addresses or endpoints, and distinguish between typical and anomalous login behaviors based on historical baselines and/or configured thresholds. In some embodiments, analysis component 103 is configured to evaluate authentication patterns using time-based (e.g., real time) sliding windows, comparing the number of login attempts per minute against a historical baseline to detect anomalies. In some embodiments, the real-time sliding window is implemented using a time-decaying data structure that prioritizes recent authentication activity for threshold evaluation. In some embodiments, analysis component 103 identifies excessive login attempts that exceed 10,000 requests from a single IP address within a five-minute interval, triggering automatic blacklisting. In some embodiments, the number of requests may range from 1 request to 100,000 requests, and the unit of time, interval, or time period may range between 1 second and 30 days, and any ranges or intervals therebetween. In some embodiments, the analysis component 103 is further configured to apply behavioral fingerprinting to differentiate between automated login attempts and human-driven authentication behavior.

In some embodiments, the analysis component 103 comprises a machine learning model trained on historical authentication request data to dynamically adjust the predefined threshold based on observed behavioral trends. In some embodiments, the analysis component 103 includes an anomaly detection engine employing an unsupervised learning algorithm to identify deviations from baseline authentication patterns across users or endpoints. In some embodiments, the analysis component 103 comprises a game theory engine configured to model attacker incentives and determine optimal defensive responses to disincentivize continued attack behavior.

In some embodiments, the mitigation component 105 (e.g., a dynamic threat response component or module) is configured to automatically initiate a mitigation action when anomalous authentication activity is detected. In some embodiments, the mitigation action comprises at least one of: imposing a cooldown period on further login attempts from the source network address, temporarily or permanently blocking the source IP address, and/or throttling or delaying login attempts from said source. In some embodiments, the mitigation action comprises applying a progressive cooldown algorithm that increases the delay for subsequent authentication attempts after each consecutive failed attempt from the same source. In some embodiments, the mitigation component 103 comprises an IP whitelisting mechanism that permits the exclusion of pre-approved trusted IP addresses from automated mitigation actions. In some embodiments, the mitigation action comprises sending administrative alerts with contextual threat diagnostics, such as IP origin, attempt frequency, and affected services in order to facilitate forensic review. In some embodiments, the mitigation component 105 is further configured to dynamically adjust the predefined threshold based on time of day, historical usage patterns, or authentication system load. In some embodiments, the mitigation component 105 comprises a fail-open mechanism configured to disable automated responses when system health metrics indicate a potential self-induced denial of service.

In some embodiments, the mitigation component 105 is further configured to manipulate network traffic characteristics for authentication requests from endpoints exceeding the predefined threshold to create a perception of a larger or geographically distributed network topology. In some embodiments, the traffic manipulation comprises at least one of: injecting artificial latency, modifying packet time-to-live values, and simulating distributed server response patterns.

In some embodiments, the mitigation component 105 is configured to redirect authentication requests from endpoints exceeding the predefined threshold to one or more honeypot systems that simulate one or more systems (e.g., authentication systems). In some embodiments, the honeypot systems comprise at least one of: an internal virtualized honeypot, a downstream honeypot network, an upstream honeypot network, an upstream honeypot network, an upstream honeypot network coordinated through communication with internet service providers.

In some embodiments, the mitigation component 105 is further configured to employ artificial intelligence to develop and deploy attack-specific countermeasures based on analysis of attack patterns observed in honeypot environments.

In some embodiments, the mitigation component 105 comprises an automated system for communicating with one or more internet service providers about attack sources. In some embodiments, the communication includes automatically researched provider-specific contact information and appropriately formatted abuse notifications.

In some embodiments, system 100 further comprises an intelligence gathering component that analyzes attack patterns captured in honeypot systems and feeds behavioral signatures back to the analysis component to improve detection capabilities.

Referring now to FIG. 1B, shown is an exemplary cybersecurity system 100. In some embodiments, system 100 further comprises a logging component 107 (e.g., a logging and correlation component or module) configured to collect system logs and failed login records from multiple services, including VPN appliances and email systems, and identify correlations between excessive authentication attempts and system performance degradation, log flooding, or service disruption. In some embodiments, logging component 107 aggregates failed authentication events (e.g., login events) across multiple services including email servers, directory services, virtual networks, and/or VPN appliances and identifies interrelated anomalies suggestive of a coordinated attack. In some embodiments, the logging component 107 is further configured to initiate a tiered escalation protocol, comprising transmission of real-time alerts to administrative consoles, SIEM platforms, and third-party threat intelligence systems. In some embodiments, the logging component 107 is further configured to continuously label and feed failed authentication request data into a supervised learning pipeline to improve future threat detection accuracy.

In some embodiments, system 100 further comprises a firmware component 109 (e.g., a firmware interface) adapted to receive configuration and mitigation instructions from the mitigation component 105 and enforce protective actions at the VPN or authentication appliance layer. In some embodiments, firmware component 109 is embedded in a VPN appliance and is adapted to enforce network-layer blocks and cooldowns without requiring modification of underlying authentication servers. In some embodiments, the firmware component 109 is implemented within a network appliance positioned inline between client endpoints and the authentication systems, and configured to operate independently of the authentication protocol used. In some embodiments, the firmware component 109 is further configured to queue and replay legitimate authentication requests that occur during a mitigation event, thereby preserving user access continuity.

In some embodiments, system 100 is configured to mitigate distributed or concentrated login-based attacks that may cause system crashes, memory leaks, service interruption, or false administrative alerts. In some embodiments, system 100 prevents authentication transaction flooding by enforcing limits and behavioral protections that are not limited to traditional rate-limiting or local authentication disabling. In some embodiments, system 100 is configured to detect repeated failed login patterns indicative of memory leak exploitation, and initiate protective measures prior to the exhaustion of system resources. In some embodiments, system 100 further comprises an API integration layer configured to expose authentication activity metrics and mitigation outcomes to external monitoring or orchestration systems.

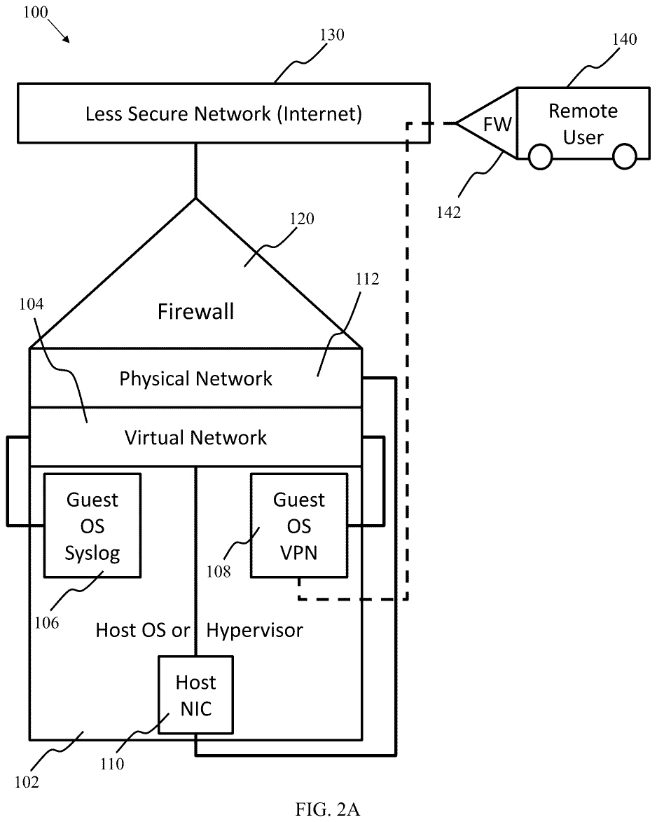

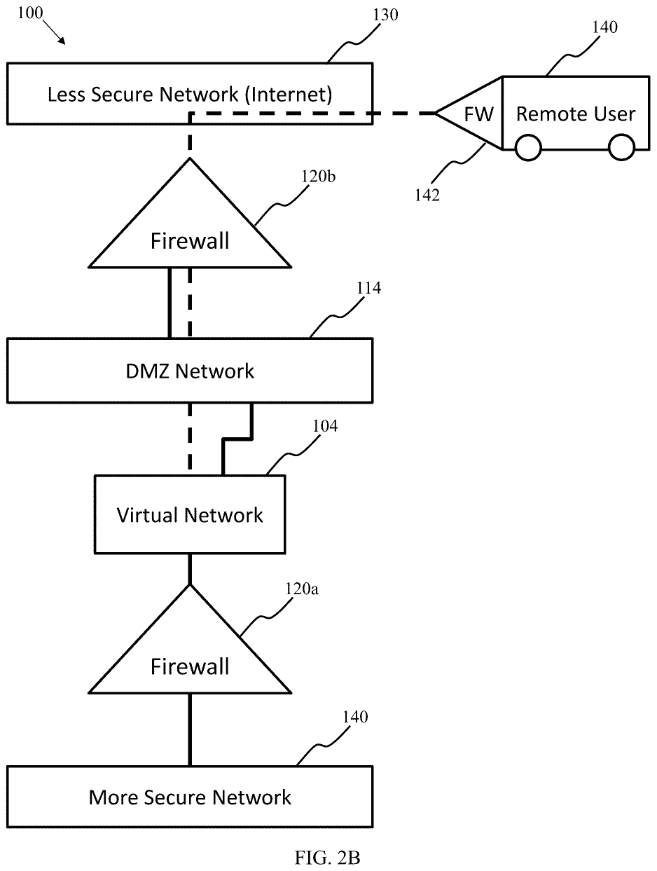

FIG. 2A is a diagram of an exemplary system 100 comprising one or more assets or components configured as a virtual system. In some embodiments, system 100 comprises one or more host OS 102. In some embodiments, the one or more host OS 102 comprises a VMM (e.g., a hypervisor). In some embodiments, a virtual network 104 (e.g., a virtual network appliance, a virtual private network (VPN)) lives in host OS 102 and is protected by a firewall 120. In some embodiments, the firewall 120 allows access from any IP on a less secure network 130 (e.g., the internet) to the virtual network 104 while protecting the other assets from unsolicited access. In some embodiments, the host OS 102, and/or the virtual network 104 thereof, comprises a guest OS system log 106 and a guest OS virtual network 108 (e.g., a VPN). In some embodiments, system 100 comprises at least one network interface 110 (e.g., a network interface controller (NIC)) that connects virtual network 104 to a physical network 112. In some embodiments, at least one remote user 140 (e.g., an external client) connects, through a less secure network 130 to guest OS virtual network 108 of virtual network 104. In some embodiments, the remote user 140 comprises a firewall 142 configured to protect the user from less secure network 130.

FIG. 2B is a diagram of an exemplary system 100 comprising one or more virtual network 104 (e.g., a VPN appliance or device) configured as a hardware appliance as opposed to a virtual system as shown in FIG. 2A. In some embodiments, system 100 may be deployed in a demilitarized zone (DMZ) network 114. In some embodiments, a more secure network 140 connects to the virtual network 104 with a first firewall 120a. In some embodiments, a second firewall 120b connects a remote user 140 through a less secure network 130 (e.g., the Internet). The critical uniformity is there is a system which needs to be available to users in an unknown location and coming from an unknown address and to whom users must provide and prove their identify though a process commonly called atheization and audiation and untimely access.

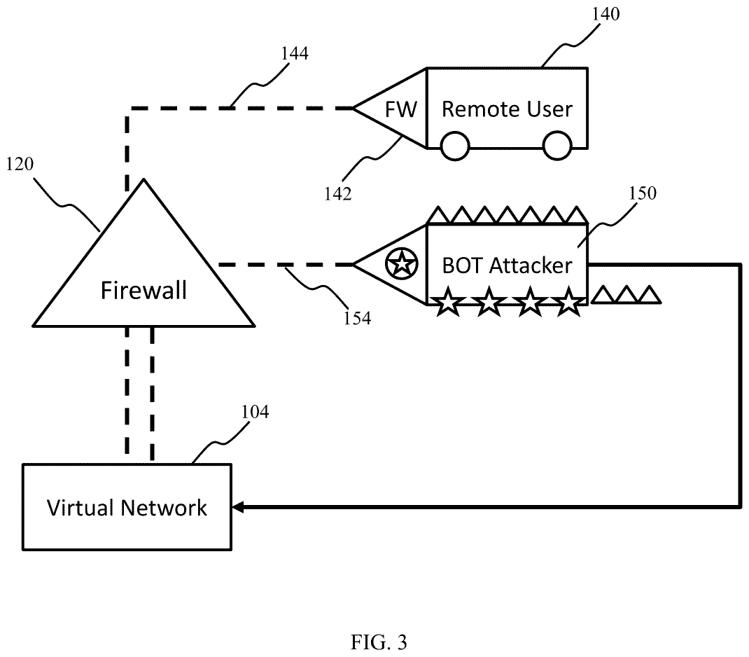

FIG. 3 is a diagram of an existing system where a remote user 140 accesses virtual network 104 through firewall 120 and has encrypted traffic 144 from the endpoint with access. Shown is one or more cyberattack 150 attempting to attack the existing system (e.g., gain access to or attack virtual network 104) with encrypted traffic 154 from the cyberattack endpoint with no access. With existing systems, there is no way for an IPS, Firewall or similar device to differentiate between attacker at the application layer (e.g., layer 7). In all cases unless the decision is made to identify remote endpoint as authorized based on their known IP, which is hard to do since these are traveling users, the VPN appliance must be accessible to all endpoints on the internet. It is a common practice to block known bad endpoints usually using their IP address or another identifying hash. This however allows unauthorized endpoints to also attempt to authenticate against the VPN appliance. Currently there is no known appliance with its own built in logic to block an endpoint that anticipates excessively. Current systems require an orchestration of many systems.

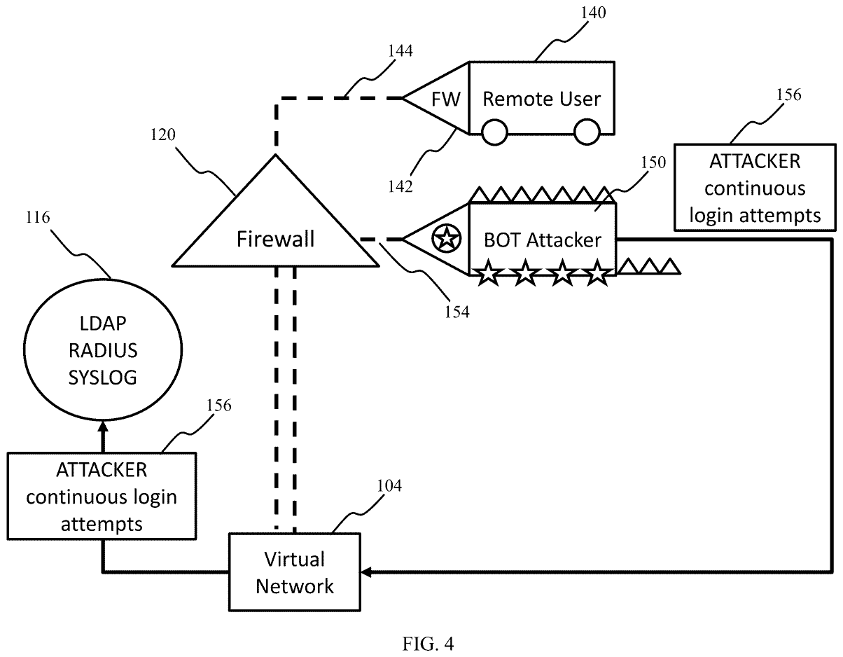

FIG. 4 is a diagram of an existing system where a cyberattack 150 attempts to attack the system with continuous login attempts 156 and shows how downstream system may be impacted. The continuous login attempts 156 can overwhelm virtual network 104 and downstream systems 116 are impacted. Downstream system 116 may comprise any of LDAP and RADIUS Servers as well as system logs. With existing systems, there is no way for an IPS, Firewall or similar device to differentiate between an attacker (e.g., cyberattack 150) at the application layer (e.g., layer 7). In all cases unless the decision is made to identify remote endpoint as authorized based on their known IP, which is hard to do since these are traveling users, the VPN appliance must be accessible to all endpoints on the internet. It is a common practice to block known bad endpoints usually using their IP address or another identifying hash. This however allows unauthorized endpoints to also attempt to authenticate against the VPN appliance. Currently there is no known appliance with its own built in logic to block an endpoint that anticipates excessively. Current systems require an orchestration of many systems or simply lockout a bad username, not a remote endpoint.

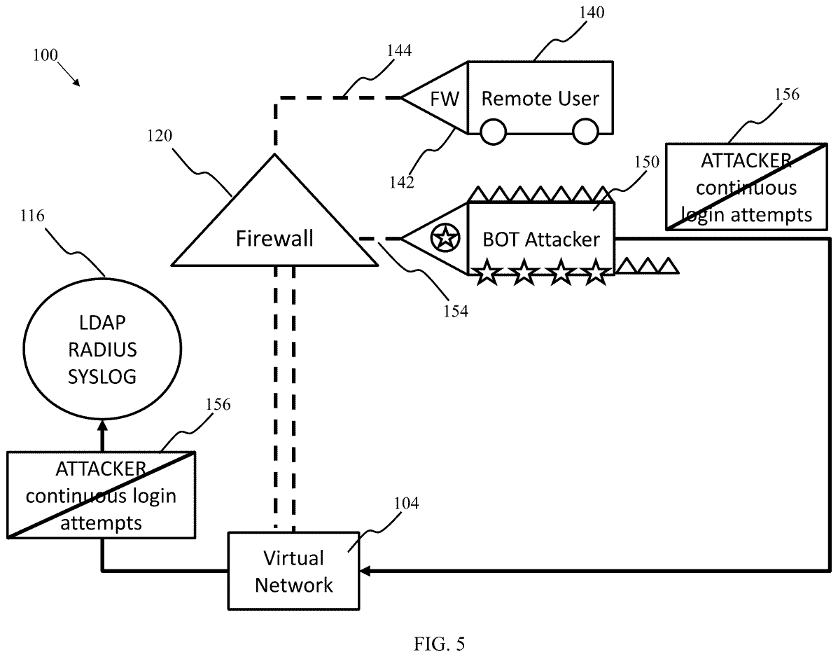

FIG. 5 is a diagram of an exemplary system 100 where a cyberattack 150 attempts to attack the system with continuous login attempts 156 and downstream systems 116 are not impacted. The disclosed technology can be incorporated into any virtual network (e.g., VPN appliance) or VMM (e.g., hypervisor solution). The disclosed system 100 provides a means for differentiating between the encrypted traffic 144 of remote user 140 and the encrypted traffic 154 of cyberattack 150, for example in the application layer (layer 7) of an IPS (e.g., virtual network 104) or firewall (e.g., firewall 120, firewalls 120a, 120b). The disclosed system 100 provides a built in logic to block an endpoint that anticipates excessively and does not require the orchestration of many systems. If endpoint based on identity (e.g., IP address or other hash type identifier) not requiring application layer (e.g., layer 7) decryption attempts to login more the X times in Y seconds, system 100 shuts down endpoint access to an authentication engine (e.g., blocks the endpoint, or stops probing endpoint authorization requests). Then, system 100 reports blocked identities (e.g., IP address, hash type identifier) to upstream systems.

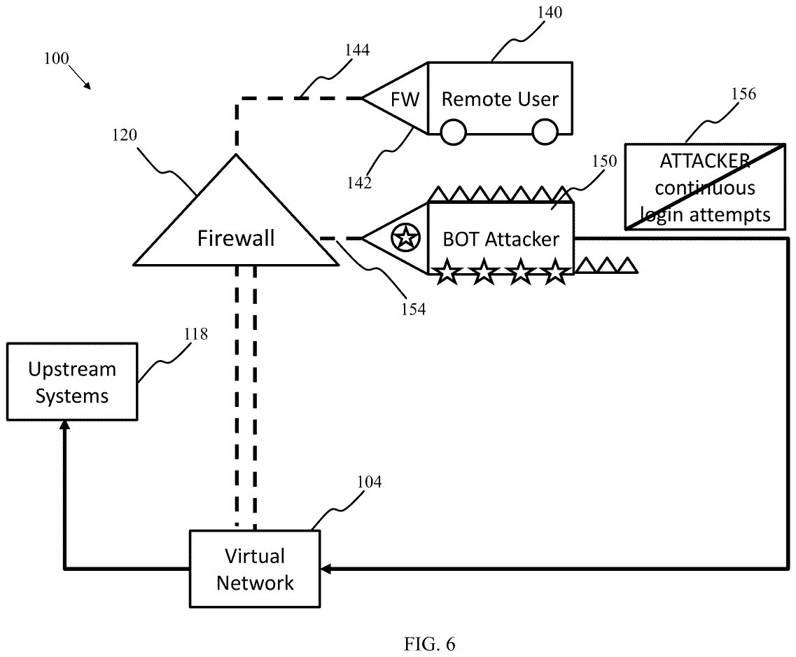

FIG. 6 is a diagram of an exemplary system 100 where a continuous login attempts 156 of a cyberattack 150 are blocked, and identifiers of the cyberattack are reported to upstream systems 118. In some embodiments, upstream systems 118 comprise any of servers, name servers, email servers, web servers, file servers, database servers, application servers, proxy servers, and the like.

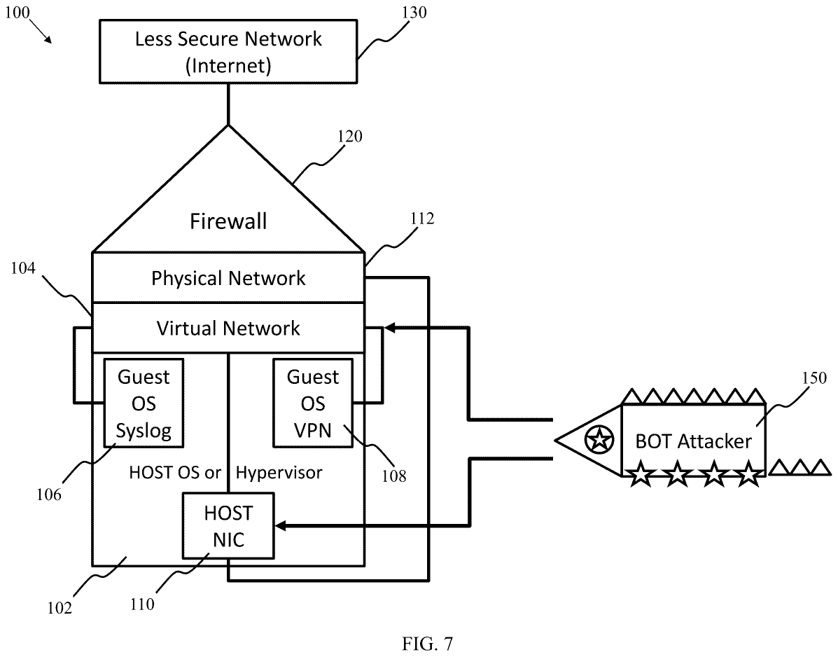

FIG. 7 is a diagram of an exemplary system 100 where a host OS 102 of a guest appliance blocks any traffic (either from its physical interface or its virtual interface) to a guest OS hosting the appliance.

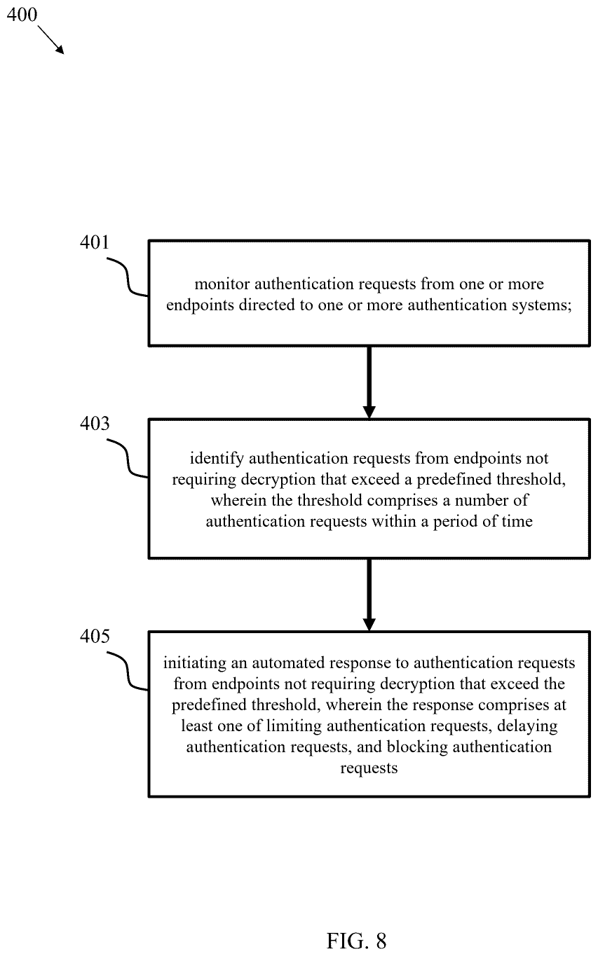

Aspects of the present invention relate to a cyber security method. Referring now to FIG. 8, shown is an exemplary cybersecurity method 400. In some embodiments, method 400 comprises the steps of 401 monitoring authentication requests from one or more endpoints directed to one or more authentication systems; 403 identifying authentication requests from endpoints not requiring decryption that exceed a predefined threshold, wherein the threshold comprises a number of authentication requests within a period of time; and 405 initiating an automated response to authentication requests from endpoints not requiring decryption that exceed the predefined threshold, wherein the response comprises at least one of limiting authentication requests, delaying authentication requests, and blocking authentication requests.

In some embodiments, the response comprises applying a progressive cooldown algorithm that increases a delay for authentication requests from the one or more endpoints after each consecutive authentication request. In some embodiments, the response comprises blacklisting the one or more endpoints that exceed the predefined threshold. In some embodiments, the number of requests range between 1 and 50,000 requests, and the period of time ranges between 0.001 second and 20 minutes.

In some embodiments, method 400 further comprises the step of whitelisting one or more endpoints to exclude the endpoints from the automated response. In some embodiments, method 400 further comprises the step of evaluating patterns of authentication requests using a real-time sliding window for comparison against historical authentication requests. In some embodiments, method 400 further comprises the steps of evaluating patterns of authentication requests that result in memory exhaustion or memory leak, and initiating the automated response based the patterns of authentication requests.

In some embodiments, method 400 further comprises the step of aggregating failed authentication requests, and transmitting a report of the failed authentication requests to upstream systems. In some embodiments, the report comprises contextual threat diagnostics comprising at least one of endpoint origin, number of authentication attempts, authentication attempt frequency, and impacted services.

In some embodiments, method 400 further comprises the step of configuring the mitigation component to redirect authentication requests from endpoints exceeding the predefined threshold to one or more honeypot systems that simulate the authentication systems. In some embodiments, the honeypot systems comprise at least one of: an internal virtualized honeypot, a downstream honeypot network, an upstream honeypot network, and an upstream honeypot network coordinated through communication with internet service providers.

In some embodiments, the mitigation component is further configured to manipulate network traffic characteristics for authentication requests from endpoints exceeding the predefined threshold to create a perception of a larger or geographically distributed network topology. In some embodiments, the traffic manipulation comprises at least one of: injecting artificial latency, modifying packet time-to-live values, and simulating distributed server response patterns.

In some embodiments, method 400 further comprises providing or configuring an intelligence gathering component that analyzes attack patterns captured in honeypot systems and feeds behavioral signatures back to the analysis component to improve detection capabilities. In some embodiments, the analysis component comprises a game theory engine configured to model attacker incentives and determine optimal defensive responses to disincentivize continued attack behavior. In some embodiments, the mitigation component is further configured to employ artificial intelligence to develop and deploy attack-specific countermeasures based on analysis of attack patterns observed in honeypot environments.

In some embodiments, the monitoring component is further configured to detect distributed authentication signals across multiple network endpoints, wherein legitimate authentication requires specific interaction patterns with seemingly unrelated services. In some embodiments, the authentication signals comprise a predetermined sequence of connections to sensor endpoints that must occur before authentication attempts will be processed.

### Computing Environment

Aspects of the present invention relate to computer software, computer systems and computer networks, and architectures thereof, that may comprise any number of computers and networking components that are communicatively coupled or connected. In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art. In some embodiments, the software operates across any number of far-edge, near-edge, and on-premises devices and/or components.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

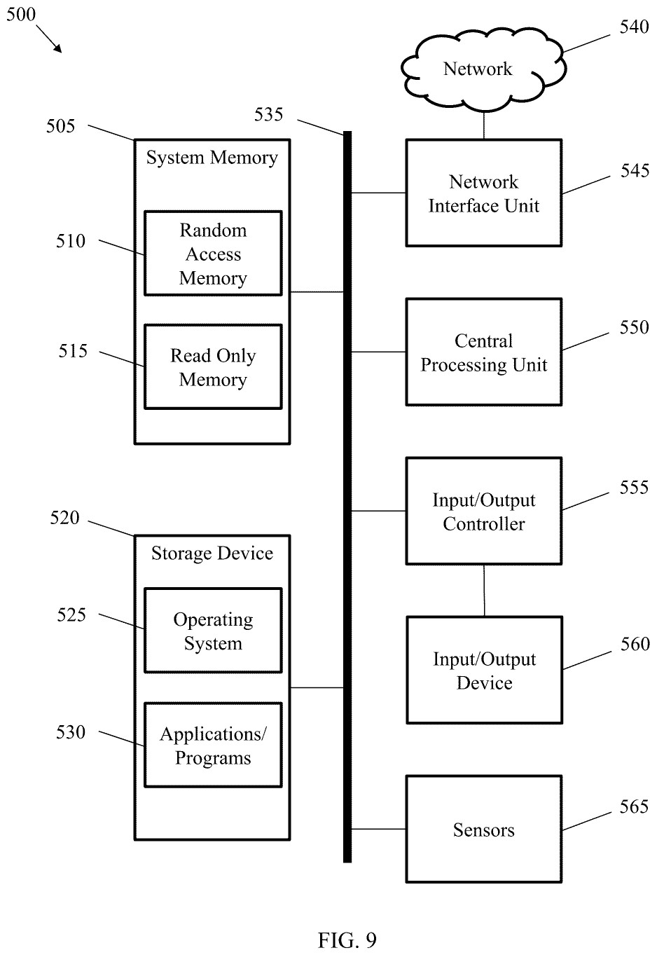

FIG. 9 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 9 depicts an illustrative computer architecture for a computer 500 for practicing the various embodiments of the invention. The computer architecture shown in FIG. 9 illustrates a conventional personal computer, including a central processing unit 550 (“CPU”), a system memory 505, including a random access memory 510 (“RAM”) and a read-only memory (“ROM”) 515, and a system bus 535 that couples the system memory 505 to the CPU 550. A basic input/output system containing the basic routines that help to transfer information between elements within the computer, such as during startup, is stored in the ROM 515. The computer 500 further includes a storage device 520 for storing an operating system 525, application/program 530, and data.

The storage device 520 is connected to the CPU 550 through a storage controller (not shown) connected to the bus 535. The storage device 520 and its associated computer-readable media provide non-volatile storage for the computer 500. Although the description of computer-readable media contained herein refers to a storage device, such as a hard disk or CD-ROM drive, it should be appreciated by those skilled in the art that computer-readable media can be any available media that can be accessed by the computer 500.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 500 may operate in a networked environment using logical connections to remote computers through a network 540, such as TCP/IP network such as the Internet or an intranet. The computer 500 may connect to the network 540 through a network interface unit 545 connected to the bus 535. It should be appreciated that the network interface unit 545 may also be utilized to connect to other types of networks and remote computer systems.

The computer 500 may also include an input/output controller 555 for receiving and processing input from a number of input/output devices 560, including a keyboard, a mouse, a touchscreen, a camera, a microphone, a controller, a joystick, or other type of input device. Similarly, the input/output controller 555 may provide output to a display screen, a printer, a speaker, or other type of output device. The computer 500 can connect to the input/output device 560 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 520 and/or RAM 510 of the computer 500, including an operating system 525 suitable for controlling the operation of a networked computer. The storage device 520 and RAM 510 may also store one or more applications/programs 530. In particular, the storage device 520 and RAM 510 may store an application/program 530 for providing a variety of functionalities to a user. For instance, the application/program 530 may comprise many types of programs such as a word processing application, a spreadsheet application, a desktop publishing application, a database application, a gaming application, internet browsing application, electronic mail application, messaging application, and the like. According to an embodiment of the present invention, the application/program 530 comprises a multiple functionality software application for providing word processing functionality, slide presentation functionality, spreadsheet functionality, database functionality and the like.

The computer 500 in some embodiments can include a variety of sensors 565 for monitoring the environment surrounding and the environment internal to the computer 500. These sensors 565 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Aspects of the invention relate to machine learning executed on a computing device, wherein the computing device may be computer 300. In some embodiments, the disclosed system and method utilize machine learning algorithms and models, including one or more neural networks, that may operate on at least one computing device (e.g., computer 500). The disclosed system may employ various types of neural networks known in the art, including but not limited to feedforward neural networks (FNNs), convolutional neural networks (CNNs), recurrent neural networks (RNNs), transformer networks, autoencoders, generative adversarial networks (GANs), Radial Basis Function Networks (RBFNs), extreme learning machines (ELMs), quantum neural networks (QNNs), and deep neural networks (DNNs).

Machine learning is a branch of artificial intelligence (AI) that enables systems to learn and improve from experience without being explicitly programmed. Machine learning models analyze data sets to identify patterns and correlations, and then use those patterns to make predictions or decisions. Machine learning models can generally be categorized into three primary types: supervised learning, unsupervised learning, and semi-supervised learning.

Supervised learning involves training a model using labeled datasets to classify data or predict outcomes accurately. As input data is fed into the model, the model adjusts its internal parameters (e.g., weights) to minimize prediction errors. Common methods used in supervised learning include neural networks, naïve Bayes classifiers, linear regression, logistic regression, random forests, and support vector machines (SVMs).

Classification is a common task in supervised learning, where data inputs are categorized into distinct classes. Classification models may include binary classifiers (e.g., spam vs. non-spam) and multi-class classifiers (e.g., identifying different species of animals). A decision tree is a widely used classification method that applies a sequence of “if-then” conditions to narrow down possible outcomes.

Regression is another form of supervised learning where the output is a continuous variable rather than a discrete category. Linear regression predicts a continuous value based on a linear relationship between inputs and outputs, while logistic regression predicts categorical outcomes based on defined inputs.

Unsupervised learning involves analyzing unlabeled datasets to identify hidden patterns or groupings without human intervention. Principal component analysis (PCA) and singular value decomposition (SVD) are common techniques used to reduce data dimensionality and reveal underlying structures.

Clustering is a key unsupervised learning technique where data points are grouped based on shared features or proximity. K-means clustering is a widely used method where the number of clusters is defined by a variable “k,” and the algorithm iteratively adjusts cluster centroids to minimize variance within each cluster. Other clustering methods include hierarchical clustering and probabilistic clustering.

Semi-supervised learning combines elements of both supervised and unsupervised learning. A model is initially trained using a smaller labeled dataset, which then guides the classification and feature extraction from a larger unlabeled dataset. Semi-supervised learning is particularly useful when acquiring large amounts of labeled data is costly or impractical.

Deep learning is a subfield of machine learning that uses neural networks with multiple hidden layers to process and analyze complex data. Neural networks mimic the structure and function of the human brain, comprising layers of interconnected nodes (neurons). Each neuron receives input data, applies a transformation based on assigned weights, and passes the result to the next layer.

A typical neural network consists of: input layer—receives raw data inputs; hidden layer(s)—applies mathematical transformations using weighted connections; and output layer - generates the final prediction or classification.

Convolutional neural networks (CNNs) are a type of neural network particularly well-suited for processing image and spatial data. CNNs use convolutional layers to extract spatial features from input data, pooling layers to reduce dimensionality, and fully connected layers to generate output predictions.

### Experimental Examples

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### Example 1: Bot Attack Blocker

Current considerations may include disabling local authentication as a potential solution to mitigate performance issues by reducing CPU load, though this still allows an attack to persist. We've devised a network layer protection that detected excessive authentication attempts—thousands in scenarios typically expecting around 100 logins per minute—and subsequently blocked the IPs responsible for this abnormal activity.

Typical strategy to disable logins and minimize system calls to LDAP or Radius servers might have alleviated CPU stress. However, we perceived the threat to be more extensive. It involved log flooding and email system inundations, creating optimal conditions for buffer overflows or system failures. This was due to excessive logging from failed login attempts, particularly problematic when managing 10,000 login attempts in five minutes, such as using SSL and NetExtender, a SonicWALL VPN tool.

The repeated failure of login attempts can cause minor memory leaks. When such failures occur millions of times within an hour, they can accumulate, potentially leading to system crashes or unauthorized access. The support systems for LDAP or Radius, which respond to the VPN requests prior to the enforcement of local authentication only, are also critically stressed under these conditions.

We are offering a fix to this frequent security flaw: a DDoS-style attack not just targeting the VPN appliance but affecting the entire authentication and logging framework. Allowing 10,000 logins from a single endpoint within five minutes is unprecedented and should not be feasible, as it could overwhelm downstream login systems and confuse administrators. Processing such a volume of transactions could likely precipitate new exploits. Our proposed mitigation involved implementing a cooldown period after a set number of failed login attempts or blocking IPs altogether when they exceed a specified failure threshold within a given timeframe. Following the implementation of the custom firmware that incorporated our suggestions, we received confirmation that our requested fix comprehensively addressed this issue.

This capability has been implemented on an intermediary system, which tested the underlying logic needed to address the issue effectively. During this period, our clients endured considerable inconvenience when we had to whitelist IPs while building and testing our system. The above provided an expedient, convenient, comprehensive solution.

### Example 2: Advanced Defensive Strategy Enhancements for Cybersecurity Systems

This example proposes additional defensive capabilities to enhance the cybersecurity system described in the patent application. These enhancements focus on adding honeypot redirection, traffic manipulation features, game theory-based response strategies, AI-driven mitigation, and alternative authentication mechanisms that would complement the existing authentication request monitoring, analysis, and mitigation components.

Honeypot Redirection System: The existing cybersecurity system can be enhanced to include honeypot redirection capabilities that operate in multiple deployment scenarios: Internal Virtualized Honeypot Implementation: The system could redirect attackers to an internal honeypot running in a virtual machine within the same physical infrastructure. Function: While legitimate traffic continues to the actual authentication systems, suspicious endpoints that trigger the predefined thresholds would be transparently redirected to isolated honeypot environments. Benefits: This approach allows for real-time analysis of attack patterns, collection of attack signatures, and isolation of malicious activity while maintaining service availability for legitimate users. Technical Integration: The mitigation component would be enhanced to not only limit, delay, or block authentication requests, but also selectively redirect them to the internal virtualized environment that mimics the production authentication system.

Downstream Honeypot Network Implementation: The system could direct traffic to a separate, dedicated honeypot network designed specifically for attack analysis. Function: This network would be fully isolated from production systems but would appear identical to attackers, capturing their techniques, tools, and procedures (TTPs). Benefits: Provides a more robust environment for studying sophisticated attacks without risking production infrastructure, while generating valuable threat intelligence. Technical Integration: The firmware component would require enhanced routing capabilities to seamlessly redirect traffic to the downstream honeypot network.

Upstream Redirection Coordination Implementation: The system could communicate with upstream devices (ISPs, edge routers, etc.) to redirect suspicious traffic to external honeypot networks before it reaches the organization's systems. Function: By sharing the identified attacker information with upstream providers, attacks can be mitigated closer to their source. Benefits: Reduces the load on organizational infrastructure and provides broader visibility into attack campaigns that might be targeting multiple organizations. Technical Integration: The logging component would be expanded to include an upstream communication protocol that shares attacker identifiers (IPs, hashes) with ISP or routing infrastructure.

Network Topology Deception through Advanced Latency Manipulation: The system could implement sophisticated traffic manipulation capabilities that create a false perception of the network's size and geographical distribution:

Quantum-Optimized Deception Orchestration Implementation: The system employs quantum algorithms to solve the complex multi-variable optimization problem of coordinating deceptive responses across distributed defense nodes. Function: Unlike classical approaches, this system simultaneously evaluates all possible combinations of deceptive responses to determine the mathematically optimal strategy for resource allocation. Benefits: Addresses the NP-hard problem of optimally distributing limited defensive resources across multiple potential attack vectors while creating the most convincing deception possible. Technical Integration: The analysis component utilizes quantum computing principles to determine the minimum set of nodes that must participate in the deception to create a coherent illusion of a specific network topology.

Multi-Node Game-Theoretic Response Coordination Implementation: Instead of each defensive system responding independently, a coordinated game-theoretic framework evaluates each potential defensive action against attacker behavior models. Function: The system maintains a dynamic payoff matrix calculating the cost-to-benefit ratio of each possible defensive configuration across the entire network. Benefits: Response patterns are continuously adjusted based on observed attacker persistence, resource investment, and adaptation strategies, creating an increasingly challenging environment for malicious actors. Technical Integration: The mitigation component implements a distributed decision-making protocol that enables coordinated actions across multiple defensive nodes while optimizing resource utilization.

Resource-Optimized Contextual Latency Modulation Implementation: The system precisely calibrates response timing across the network to create the most convincing deception with minimal resource expenditure. Function: Rather than applying uniform or random delays, the system generates contextually appropriate latency patterns that precisely mimic specific geographic or infrastructure constraints only for suspicious authentication attempts. Benefits: Creates an extremely convincing illusion of complex network topology while dynamically reallocating computational resources to maximize the perceived complexity faced by the attacker. Technical Integration: The mitigation component uses machine learning algorithms to generate contextually-appropriate delay patterns that correspond to realistic network architectures, making the deception virtually indistinguishable from legitimate infrastructure.

Adaptive Attacker Profiling and Customized Disincentivization Implementation: Machine learning continuously profiles attacker behavior to identify resource constraints, technical capabilities, and objective functions. Function: Based on this profile, the system crafts personalized latency patterns designed to specifically target the identified constraints of that particular attacker. Benefits: Maximizes the effectiveness of defensive resources by focusing on the specific weaknesses and limitations of each attacker, creating customized disincentives for continued engagement. Technical Integration: The analysis component builds behavioral profiles based on authentication patterns and uses these profiles to inform the latency modulation strategies applied by the mitigation component.

Game Theory and AI-Driven Response Strategy The system could implement advanced decision-making capabilities using game theory principles and artificial intelligence to develop optimal countermeasures against attackers:

Game Theory Matrix for Attacker Disincentivization Implementation: The system would build and maintain a game theory matrix that models attacker behaviors, incentives, and potential system responses. Function: By understanding the cost-benefit calculations of attackers, the system can determine which defensive strategies would most effectively discourage continued attacks. Benefits: Enables strategic rather than merely reactive defense, potentially causing attackers to voluntarily abandon their efforts by manipulating the perceived value proposition of the attack. Technical Integration: The analysis component would be enhanced with game theoretical models that continuously update based on observed attack patterns and effectiveness of previous mitigations.

AI-Driven Mitigation Strategy Development Implementation: Neural networks or other AI systems could analyze honeypot interactions and historical attack data to develop novel mitigation strategies. Function: The AI would continuously learn from both successful and unsuccessful attacks, identifying optimal responses for different attack profiles and adapting to new attack methodologies. Benefits: Provides a continuously evolving defense posture that can anticipate and counter novel attack strategies without human intervention. Technical Integration: The mitigation component would incorporate machine learning models trained on honeypot and production system data to generate and deploy adaptive defense mechanisms.

Automated ISP Coordination and Response Implementation: AI agents could be deployed to automatically research attack sources, identify responsible ISPs, and generate appropriate notification tickets. Function: When attacks are detected, the system would automatically gather necessary information about the attacking infrastructure and initiate standardized or AI-generated communications with the appropriate upstream providers. Benefits: Dramatically reduces response time for upstream mitigation, potentially stopping attacks at their source before significant damage occurs. Technical Integration: The logging component would be expanded to include an AI-driven communication system capable of formatting and sending notifications according to each ISP's requirements and procedures.

Alternative Authentication Mechanisms with Sensor Networks The system could implement novel authentication approaches that utilize distributed sensing capabilities to identify legitimate users:

Port Knocking with Distributed Sensors Implementation: Authentication would require specific patterns of connections to seemingly unrelated systems that act as sensors. Function: Before attempting to authenticate to protected systems, legitimate users would need to send a specific pattern of packets to designated sensor endpoints, which would then signal the authentication system to accept their connections. Benefits: Prevents attackers from even identifying the authentication mechanism, as standard scanning would only reveal apparently inactive systems. Technical Integration: The monitoring component would be enhanced to track communications across multiple decoy endpoints and correlate them with subsequent authentication attempts.

Covert Channel Authentication Implementation: Authentication signals could be embedded within seemingly innocuous actions, such as uploading specific types of files to decoy services. Function: Legitimate users could authenticate by performing actions that contain hidden signals, such as uploading images with specific characteristics to a fake photo site that serves as an authentication sensor. Benefits: Allows authentication to occur through channels that are extremely difficult for attackers to identify or replicate. Technical Integration: The analysis component would be enhanced to extract and verify authentication signals from complex data types across multiple network services.

Quantum-Inspired Multi-Site Authentication Implementation: Authentication requirements could be distributed across multiple sites and services, requiring coordinated actions that follow quantum encryption principles. Function: Authentication would require specific interactions with multiple decoy sites, with the pattern of interaction serving as the authentication key. Benefits: Creates an authentication system that is extremely difficult to reverse-engineer through standard attack methodologies. Technical Integration: The monitoring and analysis components would be enhanced to track and correlate user actions across multiple network endpoints using principles inspired by quantum key distribution.

Integration with Existing System Components: The proposed enhancements would integrate with the existing system as follows:

Enhanced Monitoring Component: Add traffic fingerprinting to identify potential targets for honeypot redirection; Implement deeper packet inspection for candidates for latency manipulation; Deploy distributed sensors for alternative authentication mechanisms; Monitor patterns across seemingly unrelated services to detect legitimate authentication sequences.

Enhanced Analysis Component: Add behavioral analysis to determine optimal honeypot redirection strategy; Implement geographic origin detection to create convincing latency profiles; Develop heuristics to identify attack traffic suitable for redirection Incorporate game theory models for strategic response selection; Implement neural networks for adaptive response strategy development; Deploy pattern recognition for covert authentication channel validation.

Enhanced Mitigation Component: Add traffic redirection capabilities to various honeypot destinations Implement packet manipulation for latency and topology deception; Create dynamic whitelisting to prevent legitimate traffic from experiencing deception measures; Deploy AI-selected countermeasures based on game theory analysis; Develop automated ISP notification systems with appropriate request formatting Implement response strategies that manipulate attacker cost-benefit calculations.

Enhanced Logging Component: Add honeypot activity correlation with original attack patterns; Implement upstream reporting for coordinated honeypot redirection Create attribution and attack campaign analysis based on honeypot interactions; Generate AI-driven ISP notification tickets with appropriate technical details; Feed attack signatures into machine learning systems for improved detection; Track effectiveness of deployed countermeasures for strategic refinement.

These enhancements would significantly expand the defensive capabilities of the cybersecurity system beyond simple threshold-based mitigation. By incorporating honeypot redirection, traffic manipulation features, game theory-based strategic responses, AI-driven mitigation strategies, and alternative authentication mechanisms, the system creates a multi-layered defense that not only protects against authentication-based attacks but also proactively manipulates attacker behavior, gathers valuable threat intelligence, and actively deceives attackers, creating a comprehensive and adaptive security solution.

Using a group of honeypots, or using a group of authentication systems or firewalls, an attacker can be triangulated or otherwise analyzed to create a profile to better understand how to disincentivize an attacker. For example, using all total data, including latency, for a larger number of endpoints, an attackers precise geographic location or method of connection can be identified, irrespective of the use of obfuscation systems like proxies or VPNs. In some embodiment, by introducing different languages on different systems, an attacker's profile can be identified and this can be fed into a game-based incentive/disincentive reward system that may be used with any cybersecurity systems and disclosed embodiments.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A cybersecurity system, comprising:
a monitoring component configured to observe authentication requests from one or more endpoints directed to one or more authentication systems;
an analysis component configured to identify authentication requests from endpoints not requiring decryption that exceed a predefined threshold, wherein the threshold comprises a number of authentication requests within a period of time; and
a mitigation component configured to initiate an automated response to authentication requests from endpoints not requiring decryption that exceed the predefined threshold, wherein the response comprises at least one of limiting authentication requests, delaying authentication requests, and blocking authentication requests.

2. The system of claim 1, wherein the response comprises applying a progressive cooldown algorithm that increases a delay for authentication requests from the one or more endpoints after each consecutive authentication request.

3. The system of claim 1, wherein the response comprises blacklisting the one or more endpoints that exceed the predefined threshold.

4. The system of claim 1, wherein the mitigation component comprises an endpoint whitelisting mechanism that excludes one or more endpoints from the automated response.

5. The system of claim 1, wherein the number of authentication requests range between 5 and 50,000 requests, and the period of time ranges between 1 second and 20 minutes.

6. The system of claim 1, wherein the mitigation component is further configured to dynamically adjust the predefined threshold based on time of day, historical usage patterns, or authentication system load.

7. The system of claim 1, wherein the analysis component is configured to evaluate patterns of authentication requests using a real-time sliding window for comparison against historical authentication requests.

8. The system of claim 1, wherein the analysis component is configured to evaluate patterns of authentication requests that result in memory exhaustion or memory leak, and initiate the automated response based on the patterns of authentication requests.

9. The system of claim 1, further comprising a logging component that aggregates failed authentication requests and transmits a report of the failed authentication requests to upstream systems.

10. The system of claim 1, wherein the report comprises contextual threat diagnostics comprising at least one of endpoint origin, number of authentication attempts, authentication attempt frequency, and impacted services.

11. The system of claim 1, wherein the mitigation component is further configured to redirect authentication requests from endpoints exceeding the predefined threshold to one or more honeypot systems that simulate the one or more authentication systems.

12. The system of claim 11, wherein the one or more honeypot systems comprise at least one of: an internal virtualized honeypot, a downstream honeypot network, and an upstream honeypot network coordinated through communication with internet service providers.

13. The system of claim 1, wherein the mitigation component is further configured to manipulate network traffic characteristics for authentication requests from endpoints exceeding the predefined threshold to create a perception of a larger or geographically distributed network topology.

14. The system of claim 13, wherein the traffic manipulation comprises at least one of: injecting artificial latency, modifying packet time-to-live values, and simulating distributed server response patterns.

15. The system of claim 1, further comprising an intelligence gathering component that analyzes attack patterns captured in honeypot systems and feeds behavioral signatures back to the analysis component to improve detection capabilities.

16. The system of claim 1, wherein the analysis component includes a game theory engine configured to model attacker incentives and determine optimal defensive responses to disincentivize continued attack behavior.

17. The system of claim 1, wherein the mitigation component is further configured to employ artificial intelligence to develop and deploy attack-specific countermeasures based on analysis of attack patterns observed in honeypot environments.

18. The system of claim 1, wherein the monitoring component is further configured to detect distributed authentication signals across multiple network endpoints, wherein legitimate authentication requires specific interaction patterns with seemingly unrelated services.

19. The system of claim 18, wherein the authentication signals comprise a predetermined sequence of connections to sensor endpoints that must occur before authentication attempts will be processed.

20. The system of claim 1, wherein the mitigation component includes an automated system for communicating with one or more internet service providers about attack sources, wherein the communication includes automatically researched provider-specific contact information and appropriately formatted abuse notifications.
